(19) United States
(12) Patent Application Publication
(10) Pub. No.: US 2025/0053139 A1
(43) Pub. Date: Feb. 13, 2025

(54) INDIVIDUAL POKER PLAYER TIME ALLOWANCE CLOCK

(71) Applicant: Randy Dale Marker, Ranger, GA (US)

(72) Inventor: Randy Dale Marker, Ranger, GA (US)

(21) Appl. No.: 18/772,949

(22) Filed: Jul. 15, 2024

Related U.S. Application Data
(60) Provisional application No. 63/517,335, filed on Aug. 2, 2023.

(51) Int. Cl. G04F 1/00; A63F 1/00; A63F 1/18

(52) U.S. Cl. CPC G04F 1/005; A63F 1/18; A63F 2001/005

(57) ABSTRACT

A device and or systems used to track and maintain a record of time used by individual poker players. This clock management system gives individual poker players a personal time clock for a finite amount of time to play out multiple hands of poker within a set time period. In essence this invention is using the premise of another skill based game called chess. In 1883, the chess clock was invented to move the game along, from days to minutes. The chess clock gives an individual player their own equal time clock to play out a game of chess within those time limits. A simple mechanism when only two players playing against each other, but much more complicated when there are hundreds, or even thousands of players playing against each other in multi-table tournaments. This is a device that uses micro-computing power to maintain a play time clock for every individual player within the tournament, that is what this invention is.

### FIELD

The disclosure relates to the use of a chess clock type system to manage the time used by individual poker players playing the game of poker. In chess when a player makes their move, they hit the button to stop their clock from counting down and in turn, activates their opponents clock to start, a back and forth system. In this disclosure, specifically a digital clock that counts down a set amount of time for an individual poker player to play their hands of poker within a set period of time in a poker tournament. In current times, this is known as a shot clock-this term taken from basketball, where a player has a limited time to take their “shot” or lose possession.

*From this point on in this application, when referencing the invented clock system device, it shall be the abbreviation “PTAC” meaning-Player Time Allowance Clock.

### BACKGROUND

The game of poker has many variations and the history of some variations go back to the 14th century. Today the most popular version is Texas Hold'em. While there is some dispute as to who invented Texas Hold'em. A Texas road gambler named T. “Blondie” Forbes is now widely credited as having created the game in its current form sometime in the 1920's. The State of Texas officially recognizes Robstown, Texas as the place Hold'em was first played.

The game originally began as a cash game, whereas 2 to 10 players sit around a table and play for the cash on the table. Cash games in poker are still the most played version of poker today, even as popular as cash games are, the invention and growth of multiple table tournaments have exploded in popularity. In cash games, time is not a factor, as players can come and go as they please. In tournaments they are timed, so they can have a reasonable end of play time to find a winner. The official tournament clock is to designate when the required blinds and ante's are increased. As each level of a tournament passes, the blinds increase, this helps a tournament progress to a winner. A tournament clock is what manages the time of the overall tournament. Even as the main tournament clock tics away, slowly decreasing all players chip stack value, there are still slow players that puts others at a disadvantage. This system manages a players time to eliminate those advantages and disadvantages. An equal distribution of time for all players.

This invention would be used in tournaments to help move the game along and to prevent players from intentionally playing slow as a part of strategy to allow the players short of chips to make it into the money payout portion of the tournament. Many players frown on slow play as it makes the game less interesting and value detracting to top stacks in the tournament. When a player plays slow, it creates a situation where players at the table are actually seeing and playing less hands than other players on other tables in the tournament, and it affects all players in the tournament. If a majority of tables are averaging 20+ hands per hour and a slow table is only averaging 15 hands per hour, that means the players at the 20+ table are paying more rounds of mandatory blinds, which creates unfair advantages within the tournament.

In today's poker, several notoriously slow pro poker players have been intentionally using slow play as part of their strategy. Articles have been written in the poker community about these players and the like, because of their incredibly slow play for every single decision. Those players successes have come at a huge cost to players at their tables, and the poker community as a whole. Players are no more allowed to waste your time, they would only be wasting their time, putting their game play in jeopardy.

### PRIOR ART

Many patents have been granted under the broad description of a “shot clock” for poker. Everyone knows that poker is a better game for everyone if played under a time restraint. The problem with the prior art, nothing is being implemented into a working solution for a “shot clock”. Given unlimited time for decisions within the game can make the game boring and put players at a disadvantage versus other players.

There are currently only two methods of maintaining a semi-acceptable speed of play. The first is calling the clock on a player, which means a floor supervisor is called to a table and initiates a count down of thirty seconds to complete their action on the hand or the hand will be dead. This causes tension and animosity between players at the table for calling the clock on others. The only other time management used today is a manual 30 second clock operated by the Dealer, that must pressed on and off at every action of every player to limit a players time. The dealer has several jobs to maintain the game, manually pressing a timer between every action in a hand of poker is not even remotely efficient. The efficiency of the PTAC system is many times more efficient than a manual timer that is used today. This system is automatically moving from player to player, controlled by the microprocessor.

### BRIEF DESCRIPTION OF DRAWINGS

FIG. 1. An overhead view of a poker table with the components and devices of this time management system invention.
#101 A view of the PTAC, this clock is connected to the PCB/microprocessor by a series of wires connected from the control panel, PCB. (Dotted lines signify under table wiring from components to the control panel microprocessor)
#102 A view of the Action Complete button. This is the button a player presses after they check, bet, or fold. This button tells the micro-controller to stop that players clock and automatically move to the next active player clockwise.
#103 A view of the embedded magnetic proximity switch that signifies to the micro-controller the location of the Dealer Button and gives the computer a starting point for each hand. A magnet within the Dealer button disc activates the embedded switch, giving the computer a real time orientation placement of the Dealer button disc, the small blind, big blind and the under the gun player location.
#104 A view of the “After Dealer” switch on the Dealer Control Panel. This switch is used to instantly restart at the first active player after the Dealer button location. It is used after the Pre-Flop betting round and later streets (“streets” is a poker term referring to flop, turn, and river community cards).
#105 A view of the START button on the Dealer Control Panel, this button starts new hands after the final players down card is dealt. This button initiates the micro-controller to illuminate the 15 second LED's countdown at the “Under the Gun” player position, or the first player after the big blind.
#106 A view of the PAUSE button on the Dealer Control Panel, this button pauses the current active players clock. This is used mid hand when all bets are made and the Dealer needs to deal the flop, turn, or river. It is also used when the hand is complete and the Dealer needs to shuffle and deal, and break periods, and during disputes that the Dealer or tournament director need to resolve. Pressing the pause a second time resumes at the last clock that was counting down.
#107 A view of the Master time reset switches. These switches reset all PTAC's to a “Full” time amount. These are only used every 2 hours during the break periods, so when the players returns from break, they will have a full reset for the next 2 hours of play. A switch for 10 handed is 600 seconds, 9 handed is 675, 8 handed is 750 and 6 handed is 1000 seconds to play for the 2 hour period. A money bubble time reset is only 150 seconds, that is initiated when a tournament is 4 players from prize pool payouts.
#108 A view of the SKIP switches on the Dealer Control Panel. These switches are turned to the on position when a player folds an active hand, this tells the computer to skip that player until the hand is over. At the end of the hand, the Dealer will turn off the skip and then shuffle and deal the next hand.
#109 A view of the LCD information display. It tells the Dealer that the dealer button is activating the proximity switch of a particular player location. It will read Dealer Button: Player 1-10, it will also allow the dealer to select a particular player location to manually change the time on the PTAC screen to the exact second to adjust moved players time via the rotary encoder on the control panel.

FIG. 2. A Flo-chart of a typical single dealt hand of Texas Holdem-the deal and first round of betting up to the flop, the actions of the players at a 10 handed table, the monitoring by the dealer plus their prompts, and the automated responses of the PTAC management computer system to control the game play in a timely manner.

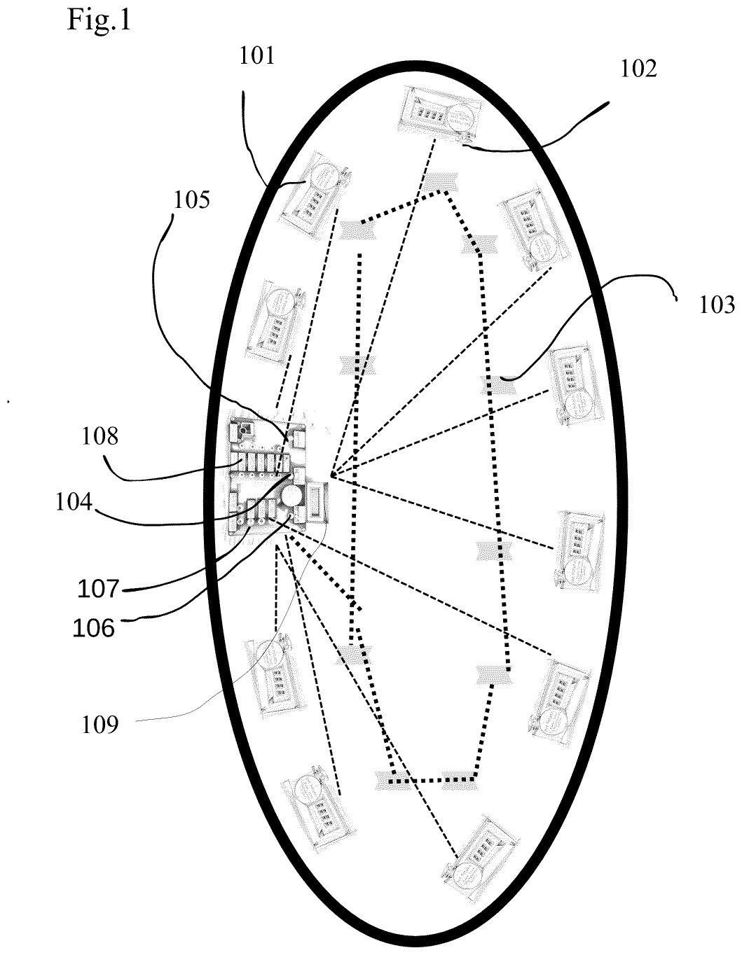

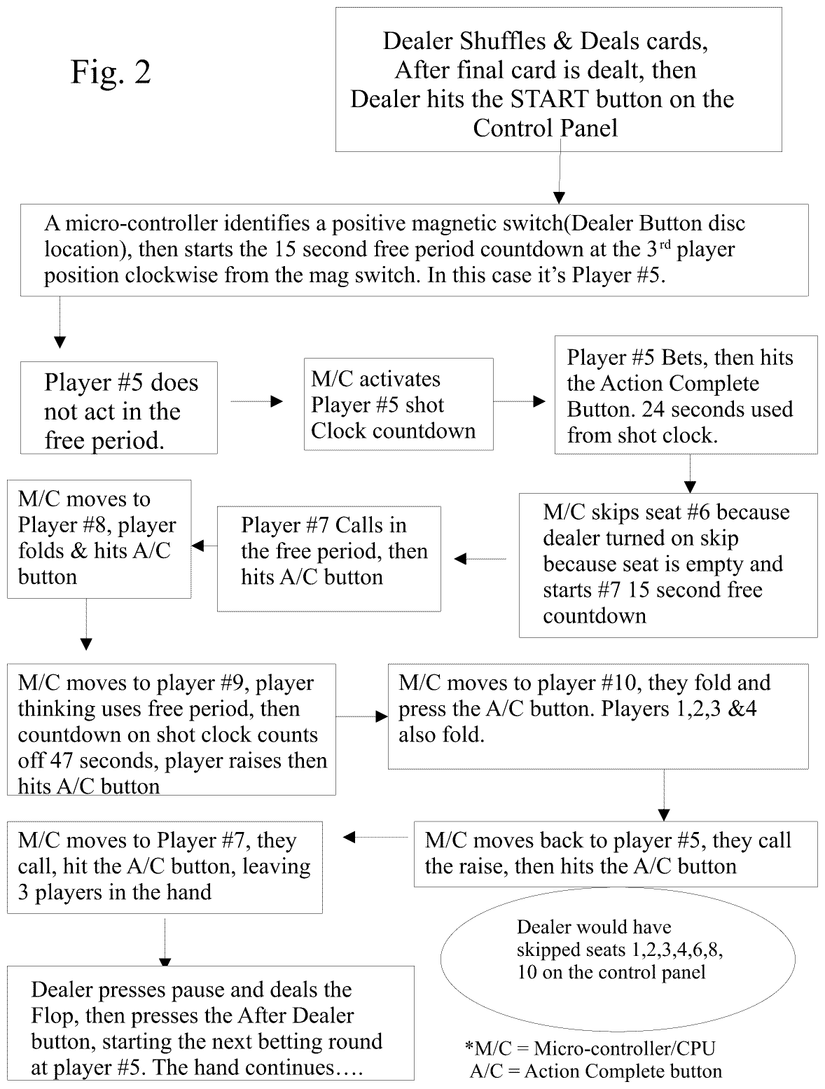

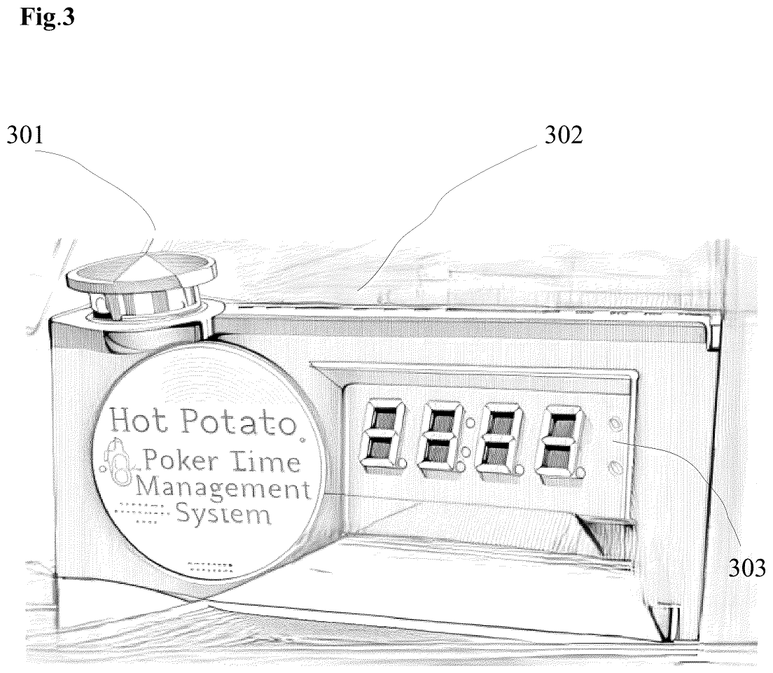

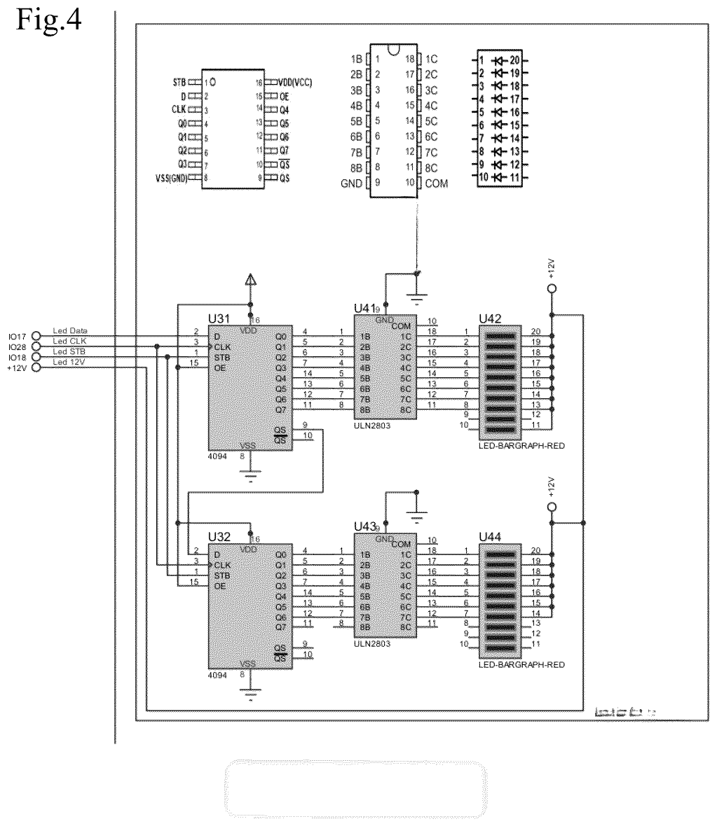

FIG 3. A view from the seated players perspective of the PTAC. #301 A view of the “Action Complete” button. This is the stop button, a player uses to stop their countdown after they have completed their required action. A player will Bet, Check, or Fold, then press the A/C button to pass the action to the next player in the hand.
#302 A view of the free period LED countdown. Across the top of the PTAC, all LED's illuminate when the action comes to the active player, one LED will extinguish as each second counts down. When all are extinguished, then the players PTAC LED screen (time bank) activates and begins to countdown.
#303 A view of the 2 LED Seven Segment/Four digit clock screens, one facing the player and the other facing out so other players can keep up with opponents remaining time as a part of strategy.

FIG. 4 A view of the LED control module schematic. This module controls the 15 LED “Free Countdown”, it consists of 2 transistors and 2 shift registers and operates on 12 volts. The first shift register controls the countdown sequence of the 1-8 portion of the 15 second LED countdown and the second shift register controls the 9-15 portion of the countdown. The hardware and the wiring sequence are shown for proprietary design and patent protections within this filing.

### DETAILED DESCRIPTION:

Modifying Players behavior playing poker in a tournament with time restrictions.

This disclosure details the processes of operational theory, play and manufacture of the Poker Players Time Allowance Clock. As previously indicated, this clock device system shall be referred to using the abbreviation “PTAC”, (Players Time Allowance Clock) for the rest of this application.

Within this description, it will also explain Texas Holdem Poker Tournaments to a layperson, not familiar with the game, so a complete understanding of the described art and use of the invention within the game. This is a device that works in concert with the game of poker to make the game more efficient, therefore it must work automatically within the exact parameters of game play. This device is not limited to only Texas Holdem Poker. There are many variants of poker in which this time limiting system will be beneficial to various poker game variants.

A multi-table tournament also known as “MTT's” can be played in a single day or over multiple days. Because of multiple starting days in large fields of players, those tournaments could take anywhere between 2-8 days to get down to a winner. In MTT's, it is predetermined the number of levels of play per day. Once the tournament plays to the predetermined level, then the players that are remaining will count and bag up their chips, record the time remaining on their PTAC, place all in the bag and seal. They will resume the day 2 at the last level played and all players clock times will be set at their new seats upon start of play when the tournament resumes. This procedure will repeat until a winner is crowned.

A Texas Hold'em tournament has blinds and ante's to help the progression of the tournament to a winner. Blinds are a required amount for the player in the small blind and the player in the big blind to pay to play the hand. This is required of all players, as the dealer button moves clockwise around the table, progressing one spot after every hand, the blinds are always the first two hands to the left of the dealer button.

At the beginning of a tournament the blinds start out very low, usually 100 small blind and 100 big blind. Some tournaments begin level 2 with a 100 small blind and a 200 big blind, plus this level usually starts the required ante that the big blind has to also pay and it always equals the big blind, so that player has to pay 200 big blind and 200 ante. This progresses the tournament to constantly shrink the players chip stack value. The blinds and ante's can get into the hundreds of thousands before the end of the tournament.

A players current progress in a tournament is always assessed by the number of big blinds their chip stack equals. The tournament operators also provide players with an average number of big blinds that players have across all tables, so players know where they stand in the tournament. Most players feel they are getting into the danger zone of busting the tournament when they are sub 15-20 big blinds. This tends to limit these short players to go into an All-in or fold type of play.

### The Tournament Begins

When using the PTAC system in a tournament, a player is issued a table seat assignment and a starting stack of poker chips. The player proceeds to their seat assignment, give their seat card to the dealer, places their chips on the table. The Dealer will turn off all seat skips on the control panel as the players take their seats, each PTAC will have a full time set on the clock screen.

At the beginning of the tournament all clocks are set to a certain amount of time for the player to play all hands of poker for a 2 hour period. The amount of time is determined by the total number of players at each table. In tournaments, the number of players per table is predetermined before the start of the tournament. Most tournaments are 10 handed, or 10 players per table, but there are some that are 9 handed, some that are 8 handed, and some that are 6 handed. The number of players per table determines that starting time on everyone's PTAC.

There is a total possible amount of play time of 120 minutes or 7200 seconds in a 2 hour period. If a table is 10 handed, then an equal division of time between all 10 players would be 720 seconds, but since it takes time to shuffle and deal the cards, plus the time required to change dealers 3 times in a 2 hour period, then a deduction of 1200 seconds is removed from the 7200 total to give players an actual play time of 6000 seconds in a 2 hour period. Using 6000 seconds as the base figure of play for the 2 hour play play period, then 10 handed players would start with 600 seconds, up to 1000 seconds for each player at 6 handed tables.

MTT's provide players with a break every 2 hours, at that time the dealer will reset all PTAC's to a full starting time for the next 2 hour play period (the Dealer uses a keyed switch on the control panel to reset players PTAC screens). If a player should use all the time on their PTAC, then during all future play for the remainder of the 2 hour period, that player's clock would read ZERO, and all of that players decisions would be limited to within the 15 second Free countdown. If that player did not complete their action in the 15 second period, then the CPU would automatically move to the next players PTAC and the players hand with no time would be dead and must be mucked.

As play begins at the start of the tournament, the Director will determine a start position of the dealer button disc. Within the table is 10 magnetic sensors in the table top that detects the location of the dealer button, this tells the computer the location of the blinds and the starting point for all hands pre-flop and post-flop. The computers programming knows that the third position clockwise after the dealer button is always the first players clock to countdown preflop, that player is also called the “Under the gun” player position, for it is the first player to act after the posted big blind.

As the dealer finishes the shuffle and deals each player 2 down cards, after the final card is dealt, the dealer presses the Start button on the Control Panel (the control panel will be detailed more later). The Start button begins a new hand and will start the countdown on the Under the gun players PTAC. The 15 second free period LED's will all illuminate and 1 per second will extinguish, until all are out, ending the free period and if the player has not acted on their hand, then their LED screen will begin counting down until they Bet, Check, or Fold. The player, then press their Action Complete button on their PTAC.

When they press the Action Complete button, then their PTAC freezes their time remaining. If the player folded then the dealer will take their cards and turn on the seat skip on the control panel. This tells the computer to skip that player for the rest of the hand.

After that player completed their action and presses the Action Complete Button, then the CPU moves to the next active player clockwise and the process begins with that players 15 second LED free countdown, again the current player will check, bet, or fold (This is the similarity of antique Chess clock, when an opponent finishes their move and presses the clock stop, to then start the opponents clock, the only 2 differences being the clocks advance clockwise to all players not just back and forth between 2 players, the other difference being, chess does not have a 15 seconds free period). This will continue all the way back to the big blind player, which will be the last player to act if no one raised, if there were a raise, then it will continue in turn back to the last raiser.

After all the pre-flop betting is done, then the dealer will press Pause, then deal a flop (3 shared community cards) for the players still active in the hand, then the dealer will press the “After Dealer” button on the control panel (this begins the 2nd betting round). This tells the CPU to start the clock of the first active player clockwise after the dealer button. For example, if the dealer button is located at seat 5 and seat 6,7, and 8 all folded and the skip was turned on for those seats, then the computer will start the PTAC for player #9. As each player completes their action, then a turn card will be dealt, another betting round takes place, and then a final river card, and final betting round. Once the final river bet is called, the players will table their hand, the dealer will press pause on the control panel, the winning hand will be passed the pot.

Beginning the next hand, the dealer turns off all skips on the control panel from the previous hand, then moves the dealer button clockwise to the next player (first two players left of dealer button will post the small and big blind and ante). Now that all players PTAC's are now active, the dealer will shuffle and deal the new hand, after all cards are dealt, the dealer will press Start on the control panel repeating everything described previously.

In MTT's when players lose all their chips, they are busted and are out of the tournament, when this happens the Director must balance tables to keep all tables full. The Director will randomly pick a full table, then move the player that would be in the big blind of the next hand, then move that player to a table that is short, keeping tables full and eventually reducing the number of overall tables as more players bust out of the tournament. When a player is told to move, they are given a seat card of the table they are to move to, additionally the Director would record the moved players PTAC time and that would be given to the dealer at the new table so the players time can be entered at the new seat location. That player will continue at their new table with that starting amount of play time until the next break reset. This time adjustment for the moved player is changed by the dealer via the control panel. The dealer will take the recorded time and adjust the new players PTAC to reflect that time, using the rotary encoder on the Control Panel to adjust the time up or down to the exact second.

As mentioned earlier, in multiple day tournaments, at the end of the day 1-2-3 etc, the remaining players are given bags. They complete a form with their name, chip count and the time remaining on their PTAC's. The dealer will verify the time recorded. They will keep a copy, place a copy in the bag and seal, and give the dealer a copy of the form. These bags are securely stored until the tournament resumes the next day. When play resumes, players are randomly placed at new tables, the dealer will input the recorded time on the PTAC and all players will begin play exactly at the same point as the previous nights play.

The above operational theory is defined very rigidly as it must follow the parameters of the game of Texas Holdem. The game is played in a specific way and the PTAC system must follow the game exactly as it is played. The examples given in the description follow the game of Texas Holdem but this timing system is not limited to that single example, as it can be used with any Poker game that benefits by time limiting structures.

The rigidly described operational theory also sets an exact starting time for all PTAC'S, the basis for the set starting times are from the 6000 seconds total net play time in a 2 hour period, evenly divided between the players at each table. If in real life play, as trends in poker change, if it is found that the starting time gives players too much time, or not enough time for the 2 hour play period, then starting times will be modified as necessary for maximum efficiency.

The system components of the PTAC system is based on a 10 handed setup. Each table system is equipped with 10 player clocks, a magnetic proximity switch at each player position embedded under the tabletop, the Dealer Control Panel consisting of the main microprocessor and game controlling switches. Power supplies of 12 volt and 5 volts provide power to all components above and below the table top. Each player clock consists of 2 Seven Segment 4 digit LED screens, 15 individual LED's, a LED control module, and a mushroom stop switch.

The Dealer Control panel has 10 Skip toggle switches to manually skip players missing from the table, or that have folded an active hand. It has a Pause button, this pauses all clocks during shuffles/dealing, breaks and when floor personnel is called to settle a player dispute. This is a true pause button, whereas if pause is pressed a second time, the computer resumes the countdown at the same PTAC position.

The Start button, starts a new hand after a shuffle, based on where the dealer button is located, then the CPU starts the countdown of the Under the Gun player positon, which is the 3rd position left of the dealer button located on the table. The “After Dealer” switch is used to start the countdown of the first active player left of the dealer button on the table. This switch is used after the flop or reraised hands. 5 preset time switches, a preset time is designated for each player per table count, 10 handed,9,8, and 6 handed tables. The last preset time switch is 150 seconds, to be used when the tournament approaches the money bubble (explained below), it is used when 4 players from the money.

The Control Panel's final switch is an encoder rotary switch, it is used to adjust a moved players time from the previous table. There is an LCD display screen that tells the location of the Dealer button disc, this is to tell the dealer that the computer recognizes the correct position of the dealer button disc, the screen also displays the time value when manually changing a moved players PTAC time via the rotary encoder.

Explaining the “Money Bubble”, most tournaments pay between 12 & 15% of the total number of players, so if a tournament had 1000 players, then if at 12% pay scale, then 120 players would get a portion of the total prize pool. So when the tournament has 124 players remaining, then the tournament being only 4 players from the money, the Director would instruct the dealers to set all PTAC's to 150 seconds via the control panel preset, to prevent players with very little chips from stalling. The tournament would continue play for 30 minutes and if they are still above 120 players, then everyone would get another 150 seconds reset and this would continue until only 120 players or less remain in the tournament. The time of play is reduced for shorter tables, example 6 handed tournaments would play for 16 minutes between the 150 second resets when on the money bubble. The systems ability to end stalling during this time with rigid, equal time restraints, along with use of dry erase boards to record exact ALL-IN times, allows for tournament play to continue through Money Bubbles without any delays, saving hundreds of hours annually to each hosting casino or poker room. All currently ran tournaments, both with shot clocks and without, all use the “Play one hand & Stop” method at money bubbles, which requires stopping the main tournament clock and deducting 2 minutes for all tables to play one hand. This slows the tournament to a stop, and can take up to an hour plus to get through hand for hand play stoppages. When using this system, all players time is reduced to 150 seconds, that ensures all tables continue to play at normal tournament speed. And when used with the Dealers ability to record All-In times from the main tournament clock on dry erase boards. All hands are then played out in proper order and the losing players get the proper order of elimination and payouts.

This is the reason there is not overt stalling at money bubbles in Online Tournaments, the computer knows the exact second each player busts out of the tournament and the tournament plays continuously through without stoppages. If 3 players bust out, the All-In times are recorded by the computer and for example Player #1 is All-In at 14:22 and busts, Player #2 is All-In at 14:08 and busts, and Player #3 is All-In at 13:59. When using this system live, the Dealers would record the All-In time and play out the hand, in the example, Player #3 would be the last to bust at 13:59 and would be the first player paid if the tournament was 3 players from the money. No “Hand for Hand” stoppage required.

The Control Panel's final switch is an encoder rotary switch, it is used to adjust a moved players time from the previous table. There is an LCD display screen that tells the location of the Dealer button disc, this is to tell the dealer that the computer recognizes the correct position of the dealer button disc, the screen also displays the time value when manually changing a moved players PTAC time via the rotary encoder.

This system uses an integration of (ASIC's) Application Specific Integrated Circuits, enabling configuration and reconfiguration of required tasks. Conversion of signals and inputs read by an interface interpreted to do the required system actions. One or more micro-controllers to control when to start a players PTAC. Communication protocols configured to communicate between the control panel CPU and the peripheral devices.

These elements are part of a circuit structure of hardware, software, and memory devices to complete the tasks required to create the overall system/devices.

Various changes and modifications to the present embodiments described herein will be apparent to those skilled in the art. An example would be, the description of an embodiment with several components in communication with each other does not imply that all such components are required, or that each of the components must communicate with every other component as disclosed.

For further reference and to assist in the complete understanding of the art within this invention beyond the required written description and drawings, an external video of a working complete model of this invention is being provided for anyone viewing this patent application.

It should be noted that this application is providing all the required information to complete the filing for patent according to the standard established practices according to Federal statutes for patent applications, past and present.

*The video on You Tube is for voluntary supplementary informative purposes only, and not a part of this application. You Tube Title: Hot Potato poker shot clock.

The invention claimed is:

1. A system with a series of devices comprised of hardware and software, working under a singular program to operate in concert with the game of poker, specifically multiple table tournaments.
1a. The system follows game play parameters, through automatic sensors, and through manual inputs from the players, and the Dealer, to control a players allowed time to play hands of poker.

2. A system comprised of a processor(s), and memory devices that stores a plurality of instructions that, when executed by the processor to effect several components to complete required actions that are described herein, and within the poker game it is assisting in automatic time management.
2a. Within the operating system, an automatic movement player to player shot clock that modifies current poker play behaviors.
2b. The ability to track a players time use during play and from table to table.
2c. A system that makes time management a part of a players strategy to win.

3. The first system that ends “Hand for Hand” tournament clock stoppage at money pay bubbles in live tournaments.
3a. The systems ability to end stalling during pay bubbles with rigid, equal time restraints.
3b. The most reliable accounting system to ensure proper order of payouts during money bubbles. (When used with dry erase boards for recording All-In times.)
